(19) United States
(12) Patent Application Publication
(10) Pub. No.: US 2018/0033183 A1
(43) Pub. Date: Feb. 1, 2018

(54) SPLASH PARTICLE SIMULATION APPARATUS AND METHOD BASED ON VIRTUAL PARTICLE

(71) Applicant: MACROGRAPH Co., Ltd., Daejeon (KR)

(72) Inventor: Ki Ju PARK, Seoul (KR)

(73) Assignee: MACROGRAPH Co., Ltd.

(21) Appl. No.: 15/280,356

(22) Filed: Sep. 29, 2016

(30) Foreign Application Priority Data
Aug. 1, 2016 (KR) 10-2016-0097977

(51) Int. Cl. G06T 13/80; G06T 7/20; G06T 7/70; G06K 9/46; G06K 9/62

(52) U.S. Cl. CPC G06T 13/80; G06K 9/4671; G06K 9/6218; G06T 7/70; G06T 7/20; G06K 2009/4666

(57) ABSTRACT

Provided is a virtual-particle-based splash particle simulation apparatus including: a splash grid generation module configured to generate a grid including all splash particles of a current frame by using splash particle information of a previous frame; a splash particle information collection module configured to collect splash particle information of a periphery of the grid by using the generated grid and splash particle information of an inner portion of the grid; a virtual particle generation module configured to generate virtual particles by using the collected splash particle information; and a virtual-particle-based simulation module configured to perform simulation on the splash particles of the current frame by using information on the virtual particles and to allow the splash particles which are subject to the simulation to be input to the splash grid generation module in the next frame so as for the simulation to be performed.

### CROSS-REFERENCE TO RELATED PATENT APPLICATION

This application claims the benefit of Korean Patent Application No. 10-2016-0097977, filed on Aug. 1, 2016 in the Korean Intellectual Property Office, the disclosure of which is incorporated herein in its entirety by reference.

### FIELD

The present invention relates to a splash particle, and more particularly, to a splash particle simulation apparatus and method for more vividly and accurately expressing a result of liquid simulation used for special visual effects in animation, movies, or the like.

### BACKGROUND

Many methods for fluid simulation have been developed in field of computer graphics. In recent, simulation of visco-elastic fluid or visco-plastic fluid as non-Newtonian fluid has been actively studied. The methods for fluid simulation are mainly classified into a grid-based Lagrangian methods and a particle-based Eulerian method. Because the two methods have their own advantages and disadvantages, the two methods are used to be complementary to each other.

First, among the methods, a particle-based visco-elastic fluid simulation method is a method using a mass-spring model which is widely used to model a particle. In this method, elasticity is expressed by adjusting position of the particle in proportion to a relationship of L-γ between a spring rest length L of a spring introduced to connect adjacent particles and a particle distance γ. Namely, according to the property of a spring which is to maintain a constant length, if the particles approach each other, the particles repulse each other; and if the particles are far away from each other, the particles attract each other. Plasticity is expressed in such a manner that the values of the spring rest length of the spring are changed in the distinguished cases of pulling and pushing. Viscosity is expressed in such a manner that, according to the function of the viscosity which smooths the velocity, an impulse force is exerted in accordance with a relationship between the particle positions and the relative velocity only in the situation that the particles approach each other. In the method, the spring is inserted or removed according to to the arrangement of the particles, and the characteristics of the visco-elastic fluid are controlled by the inserted spring. Therefore, there is a limitation in generally modeling the characteristics of the movement of the visco-elastic fluid.

Second, there is a method directly following the SPH method, in which pressure is calculated by using a solution of Poisson equation and a co-rotational Maxwell visco-elastic model. In the method, in order to solve an unrealistic particle clustering phenomenon caused by an irregular particle distribution as a problem of particle-based methods, the particles are allowed to be regularly distributed by using a particle re-sampling method such as down-sampling and up-sampling. In the down-sampling, if two particles approach each other within a reference value, the particles are added; and in the up-sampling, a region having a low distribution of the particles is detected, particles are inserted to maintain a uniform particle distance. In particular, as a situation frequently occurring in the visco-elastic material, the particle clustering phenomenon is dominant in the case where the material is pulled. In this case, if the method is applied, a good result can be obtained apparently. However, in the method, since the particles are added or removed according to an arbitrary standard, there is also a limitation in generally modeling the characteristics of the visco-elastic fluid.

Third, there is a particle-based visco-elastic fluid simulation method which has been studied in the field of non-Newtonian fluid mechanics. Under the consideration that, in a pure SPH method, due to tensile instability, it is hard to simulate a free surface of a visco-elastic fluid, the above problem is solved by adding artificial stress. In the method, it is possible to obtain a good result that the free surface is simulated without crack by applying the artificial stress to two-dimensional simulation. However, in the free-surface simulation of the fluid, plasticity is not treated, and thus, it is hard to simulate various types of visco-elastic fluid. In addition, there is a problem in that, when the artificial stress applied to the method is applied to three-dimensional simulation, the associated mathematical formulas are so complicated that the amount of calculation exceeding a necessary amount is needed.

Recently, among special effects used in various movies and animations, liquid expressions have become important elements, and thus, many techniques for the liquid expressions have been developed.

However, detailed expression of considerable portions in the liquid simulation cannot meet user's demands, and thus, there has been difficulty in producing actual animation or movies. In particular, there has been difficulty in expressing various detailed phenomena such as splash occurring in a turbulent liquid flow.

As a cited literature, there is Korean Patent No. 10-0568563.

### SUMMARY

The present invention is to provide a virtual-particle-based splash particle simulation apparatus and method capable of more vividly and accurately expressing splash simulation used for special visual effects with respect to liquid in animation, movies, or the like by using virtual particles.

The object of the present invention is not limited to the above-mentioned one, and other objects can be clearly understood from the following description by the ordinarily skilled in the art.

According an aspect of the present invention, there is provided a virtual-particle-based splash particle simulation apparatus including: a splash grid generation module configured to generate a grid including all splash particles of a current frame by using splash particle information of a previous frame; a splash particle information collection module configured to collect splash particle information of a periphery of the grid by using the generated grid and splash particle information of an inner portion of the grid; a virtual particle generation module configured to generate virtual particles by using the collected splash particle information; and a virtual-particle-based simulation module configured to perform simulation on the splash particles of the current frame by using information on the virtual particles and to allow the splash particles which are subject to the simulation to be input to the splash grid generation module in the next frame so as for the simulation to be performed.

In the above aspect, the splash grid generation module analyzes a distribution of the splash particles on the basis of the splash particle information of the previous frame to generate a bounding box and generates a grid structure on the basis of the bounding box.

The splash particle information collection module collect the splash particle information including position information of the splash particles, velocity information of the splash particles, and density information indicating a degree of clustering of the splash particles by searching peripheral splash particles around each vertex of the generated grid.

The splash particle information collection module accumulates necessary values by searching the splash particles influencing each vertex of the grid by using the same hash structure as that of the grid, obtains an average value of the accumulated values after the searching of all the peripheral splash particles around each vertex is ended, and collects the average value as the splash particle information.

The splash particle information collection module calculates distances between the vertexes of the grid and the splash particles and accumulates the values by taking into consideration a degree of influence of the splash particles on the respective vertexes.

The virtual particle generation module generates the virtual particles by using the splash particle information collected on the basis of the vertexes of the grid.

The virtual particle generation module generates one virtual particle per vertex and determines a position of the virtual particle on the basis of the collected splash particle information.

The virtual-particle-based simulation module performs fluid simulation on the splash particles of the current frame by using a smoothed particle hydrodynamics (SPH) method.

In the performing of the fluid simulation on the splash particles in the virtual-particle-based simulation module, the virtual particles merely influence the splash particles in the simulation and, after the simulation on the current frame is ended, the virtual particles disappear.

The virtual-particle-based simulation module obtains an acceleration of the splash particle of the current frame by using the virtual particles and adjusts a velocity and position of the splash particle by using the obtained acceleration.

According another aspect of the present invention, there is provided a splash particle simulation method in a virtual-particle-based splash particle simulation apparatus, including: a splash grid generation step of generating a grid including all splash particles of a current by using splash particle information of a previous frame as an input received by the splash particle simulation apparatus; an information collection step of collecting splash particle information of a periphery of the grid by using the generated grid and splash particle information of an inner portion of the grid in the splash particle simulation apparatus; a virtual particle generation step of generating virtual particles by using the collected splash particle information in the splash particle simulation apparatus; and a simulation step of performing simulation on the splash particles of the current frame by using information on the virtual particles and allowing the splash particles which are subject to the simulation to be input to the splash grid generation module in the next frame so as for the simulation to be performed in the splash particle simulation apparatus.

In the above aspect, the grid generation step may include analyzing a distribution of the splash particles on the basis of the splash particle information of the previous frame to generate a bounding box and generating a grid structure on the basis of the bounding box.

The information collection step may include collecting the splash particle information including position information of the splash particles, velocity information of the splash particles, and density information indicating a degree of clustering of the splash particles by searching peripheral splash particles around each vertex of the generated grid.

The information collection step may include accumulating necessary values by searching the splash particles influencing each vertex of the grid by using the same hash structure as that of the grid, obtaining an average value of the accumulated values after the searching of all the peripheral splash particles around each vertex is ended, and collecting the average value as the splash particle information.

The information collection step may include calculating distances between the vertexes of the grid and the splash particles and accumulating the values by taking into consideration a degree of influence of the splash particles on the respective vertexes.

The virtual particle generation step may include generating the virtual particles by using the splash particle information collected on the basis of the vertexes of the grid.

The virtual particle generation step may include generating one virtual particle per vertex and determining a position of the virtual particle on the basis of the collected splash particle information.

The simulation step may include performing fluid simulation on the splash particles of the current frame by using an SPH method.

In the simulation step, in the performing of the fluid simulation on the splash particles, the virtual particles may merely influence the splash particles in the simulation and, after the simulation on the current frame is ended, the virtual particles may disappear.

The simulation step may include obtaining an acceleration of the splash particle of the current frame by using the virtual particles and adjusting a velocity and position of the splash particle by using the obtained acceleration.

According to the present invention, splash particle simulation is performed on the basis of virtual particles, and thus, the splash particle simulation is allowed to be performed more in detail and more acutely, so that the effect that it is possible to provide vivid animation or images easily and fast can be obtained.

In addition, according to the present invention, since the virtual particles are used for performing the splash particle simulation, the effect that the splash particle simulation can be performed faster can be obtained.

Due to the virtual-particle-based splash particle simulation method according to the present invention, it is possible to express splash occurring in a turbulent liquid flow which is hard to express in an existing liquid simulation technique, and thus, it is expected that the method is useful to produce animation with more vivid expressions.

Namely, due to the virtual-particle-based splash particle simulation method according to the present invention, it is possible to express and simulate the splash occurring in a turbulent liquid flow among liquid phenomena which cannot be easily expressed in an existing simulation method, it is possible to express the splash which is hard to express in the existing technique, and it is possible to produce more vivid images easily and fast.

### BRIEF DESCRIPTION OF THE DRAWINGS

FIG. 1 is a block diagram illustrating an internal configuration of a virtual-particle-based splash simulation apparatus according to an embodiment of the present invention;

FIG. 2 is a flowchart illustrating a virtual-particle-based splash simulation method according to an embodiment of the present invention; and

FIG. 3 is a diagram illustrating a splash grid according to an embodiment of the present invention.

### DETAILED DESCRIPTION

The present invention can be implemented with various changes and embodiments. Hereinafter, specific embodiments will be described in detail with reference to the drawings. However, it is not intended that the invention is limited to the specific embodiments, and it should be noted that all changes, equivalents, and alternatives within the spirit and scope of the invention are included in the invention.

Terms used in the application are used for explaining only specific embodiments, which is not intended to limit the present invention. Singular expression includes plural expression if it does not have explicitly different meanings in context. It should be noted that the term “to include” or “to have” in the application is intended to indicate the existence of features, numbers, steps, operations, components, parts, or a combination thereof disclosed in the specification but not excludes the existence or possibility of addition of one or more different features, numbers, steps, operations, parts, or a combination thereof in advance. If not differently defined, all terms including technical or scientific terms used herein have the same meanings as generally comprehended by the ordinarily skilled in the related art. Terms such as terms generally used and defined in a dictionary should be analyzed to have meanings in accordance with the meanings in contexts of related techniques, and unless the terms are not explicitly defined in the application, the terms should not be analyzed with ideal or excessively formalized meanings.

In addition, the same components are denoted by the same reference numerals, and the redundant description thereof will be omitted. Detailed descriptions of well-known techniques may be omitted so as not to unnecessarily obscure the invention.

The present invention is a technique of performing simulation of a splash frequently occurring in a flow of liquid in liquid simulation by using virtual particles extracted from a grid.

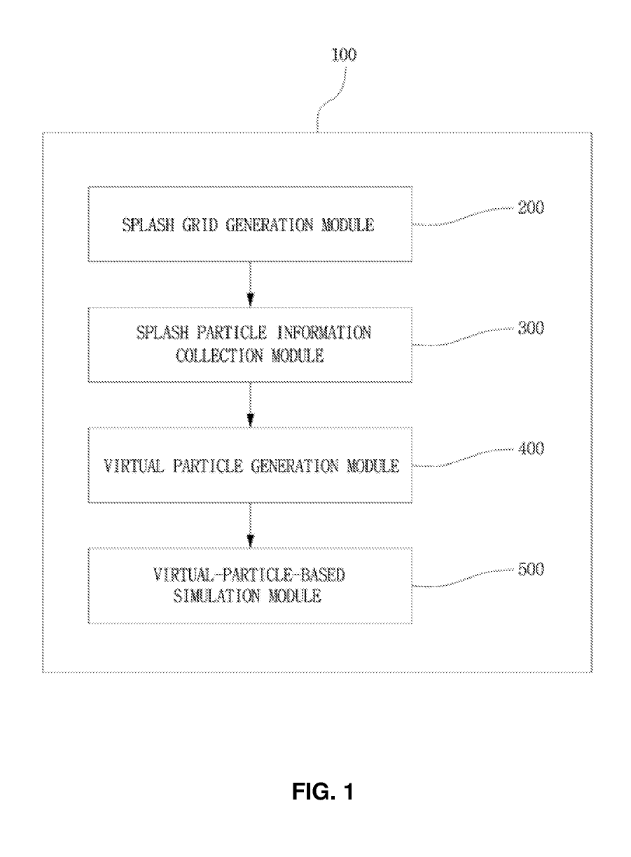

FIG. 1 is a block diagram illustrating an internal configuration of a virtual-particle-based splash simulation apparatus according to an embodiment of the present invention.

Referring to 1, a virtual-particle-based splash simulation apparatus 100 according to the embodiment of the present invention is configured to include a splash grid generation module 200, a splash particle information collection module 300, a virtual particle generation module 400, and a virtual-particle-based simulation module 500.

In the specification, the splash simulation apparatus 100 may be a general PC or computer system or may be implemented in a hardware (H/W) manner, a software (S/W) manner, or as an apparatus of a combination of hardware and software.

In addition, in the specification, a module may denote a functional or structural combination of hardware and software for driving the hardware for embodying a technical idea according to the embodiment of the present invention.

The splash grid generation module 200 generates a grid which can contains splash particles in the simulation.

The splash particle information collection module 300 collects splash particle information in the periphery of the grid by using the generated grid and splash particle information of an inner portion of the grid.

The virtual particle generation module 400 generates virtual splash particles by using collected splash information.

The virtual-particle-based simulation module 500 performs splash particle simulation by using information of virtual splash particles.

The splash grid generation module 200 uses the splash particle information of a previous frame.

In the present invention, in order to allow the virtual-particle-based simulation module 500 to perform the simulation, virtual particles are required to be generated in a grid structure on the basis of the current splash particles. For this reason, the splash grid generation module 200 generates the grid structure including all splash particles in a space.

The splash grid generation module 200 analyzes a distribution of the splash particles to generate a bounding box and generates the grid structure on the basis of the bounding box. The splash particle information collection module 300 uses the grid.

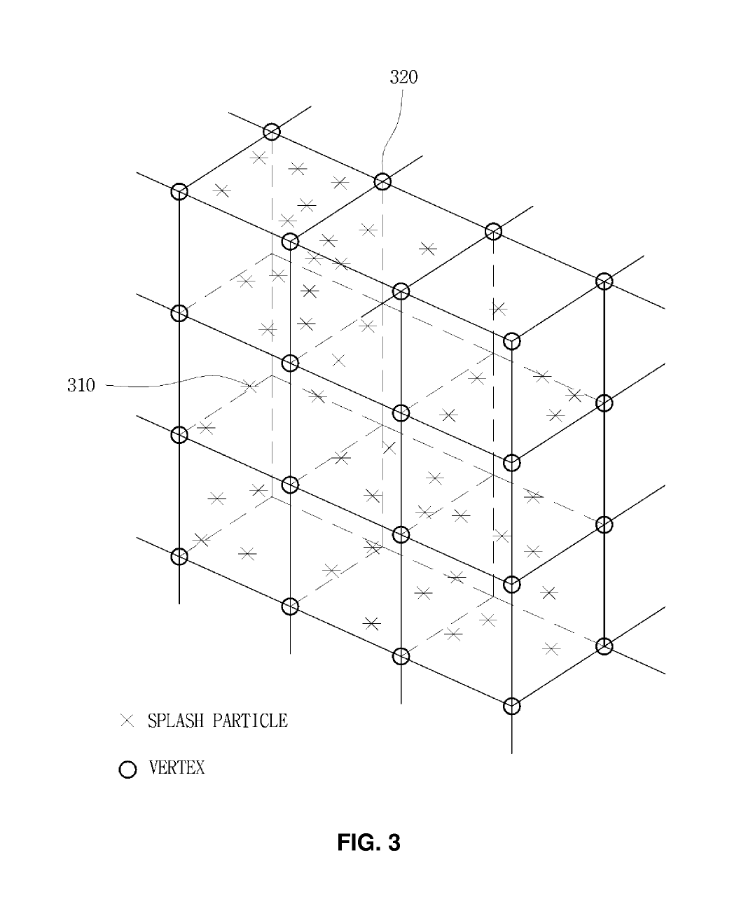

FIG. 3 is a diagram illustrating a splash grid according to an embodiment of the present invention.

Referring to 3, the splash particle information collection module 300 searches peripheral splash particles 310 by using each vertex 320 of the generated grid to collect information such as position, velocity, and density. In order to efficiently search the splash particles 310, only the particles influencing each vertex 320 of the grid are searched.

In the present invention, by searching the splash particles influencing each vertex of the grid by using the same hash structure as that of the grid, necessary values are accumulated. After the searching of all the peripheral splash particles is ended, an average value of the accumulated values is obtained, and the average value becomes final information of the splash particles collected in the vertexes.

In the collection of the particle information, distances between the vertexes 320 and the splash particles 310 are calculated, and the information is accumulated by taking into consideration a degree of influence of the splash particles on the vertexes, so that accurate collection of the particle information can be performed. The information on the splash particles collected by the splash particle information collection module 300 is used by the virtual particle generation module 400.

The virtual particle generation module 400 generates the virtual particles by using the information on the splash particles 310 collected at the vertexes 320 of the grid.

In the present invention, the collected information on the splash particles is stored in the respective vertexes 320 of the grid. The virtual particles are generated by using the collected information. Herein, the generated virtual particles are different from the splash particles on which the simulation is actually performed. The virtual particles merely influence the simulation. The virtual particles are not added to the splash particles, but all the virtual particles disappear after the simulation for one frame is ended.

The virtual particle generation module 400 generates one virtual particle per vertex of the grid. The position of the generated virtual particle is not the position of the vertex but the position collected from the splash particle. The virtual particles generated by using the information are used by the virtual-particle-based simulation module 500.

The virtual-particle-based simulation module 500 performs fluid simulation by the splash particles and the virtual particles generated by the virtual particle generation module 400.

In the embodiment of the present invention, the virtual-particle-based simulation module 500 performs splash particle simulation by using a smoothed particle hydrodynamics (SPH) method.

In general, in the SPH method, the information on the peripheral particles is collected while searching all the particles, and an acceleration of the current particles are obtained, so that the simulation can be performed. The simulation method performed by the virtual-particle-based simulation module 500 is basically similar to the SPH method, but instead of the peripheral particles, virtual particles are used to obtain the acceleration. The virtual particles are derived from the grid, only the eight virtual particles generated in the grid surrounding the current splash particle influence the current splash particle.

Therefore, in the present invention, since the peripheral particles necessary for the simulation can be easily identified and the number of peripheral particles is not large, it is possible to greatly improve the velocity in comparison with the SPH method of the related art.

In addition, in the virtual particle simulation module according to the present invention, the simulation with respect to the excessively clustered particles can be performed by obtaining the average, and thus, in comparison with the existing SPH method, stable simulation can be performed, and stable result thereof can be always obtained. After the simulation is ended, the velocity and position of the splash particle are adjusted by using the acceleration obtained in the simulation, and the adjusted velocity and position of the splash particle are supplied as an input to the splash grid generation module 200 for the next frame.

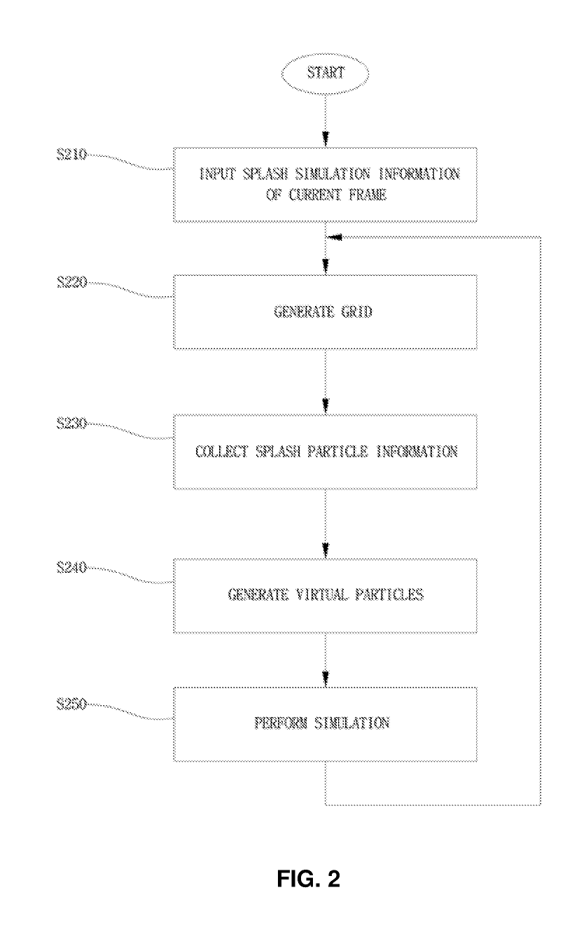

FIG. 2 is a flowchart illustrating a virtual-particle-based splash simulation method according to an embodiment of the present invention.

Referring to FIG. 2, first, splash simulation information on a current frame is received as an input (S210).

The splash grid generation module 200 generates a splash grid including all the current splash particles by using the splash simulation information received as an input (S220).

Virtual particles necessary for the virtual-particle-based splash simulation according to the present invention are generated from the splash grid. The splash grid contains position information of the generation of the grid and various types of information on the splash particles. The most necessary information is information of density and velocity of the splash particles. A grid containing all the types of information becomes a splash grid.

Subsequently, the splash particle information collection module 300 collects information on the splash particles for generating the virtual particles by using the splash simulation information (S230).

In the present invention, the virtual particles are used as an input in the performing of liquid simulation. In addition, the virtual particles need to well represent the currently-distributed splash particles. Therefore, the splash particle information collection module 300 needs to well collect the information on the peripheral splash particles to the extent that the simulation is not greatly influenced by the representation of the currently-distributed splash particles.

In the present invention, first, the splash particle information collection module 300 collects the information on the splash particles distributed in the periphery of the vertex of the splash grid, obtains the average thereof, and stores the information in the associated vertex. At this time, the splash particle information collection module 300 stores velocity information included in the information on the splash particles and checks a degree of clustering of the splash particle to calculate the density.

In addition, the average of the position information of the splash particles is also calculated, and the position information is used for generating the virtual particles in the final stage.

In the present invention, in order to obtain more accurate the averages of the velocity and position, the splash particle information collection module 300 calculates a weighting factor by using the distance between the vertexes of the grid and the splash particles and calculates the average of the velocity.

Next, the virtual particle generation module 400 generates the virtual particles by using the collected splash particle information (S240). More specifically, the virtual particle generation module 400 stores the velocity information and the position information of the generated virtual particles by using the velocity information and the position information collected by the splash particle information collection module 300 and generates one virtual particle per vertex of the grid. Herein, all the generated virtual particles have the same density, but the virtual particles have different densities

The density of vertexes calculated in the splash particle information collection module 300 is reflected on the virtual particles, and thus, the virtual particles have different densities. The generated virtual particle is used for the simulation performed by the virtual-particle-based simulation module 500.

Next, the virtual-particle-based simulation module 500 performs the simulation by using the virtual particles generated by the virtual particle generation module 400 (S250).

In the embodiment of the present invention, the virtual-particle-based simulation module 500 performs the splash particle simulation by using a smoothed particle hydrodynamics (SPH) method as one of fluid simulation methods.

The SPH method performed in the virtual-particle-based simulation module 500 according to the present invention is greatly different from a general SPH method in terms that particles on which the simulation is performed and particles which influence the simulation are separated from each other.

Namely, in the general SPH method, in a particle cluster, particles influence or are influenced by peripheral particles. However, in the SPH method performed by the virtual-particle-based simulation module 500 according to the present invention, the splash particles on which the simulation is performed and the virtual particles which are peripheral particles influencing the acceleration of the splash particles are separated from each other.

In the present invention, in order to perform the splash particle simulation, in the analysis and calculation of the influence of the peripheral particles, instead of the peripheral particles, the virtual particles are used.

In the present invention, since the virtual particles are basically particles derived from the grid, the simulation can be performed by using only eight virtual particles surrounding one splash particle. In addition, since the splash particle influenced by the virtual particles is specified, the splash particle can be searched in a very short time, and the simulation can be performed. The splash particle which is subject to the simulation is input to the splash grid generation module 200 again, and the simulation for the next frame is repeated.

On the other hand, the virtual-particle-based splash particle simulation method according to the embodiment of the present invention may be implemented as computer-readable codes in a computer-readable recording medium. The computer-readable recording medium includes all kinds of recording devices storing data that can be read by a computer system.

Examples of the computer-readable recording medium may include ROMs, RAMs, CD-ROMs, magnetic tapes, HDDs, floppy disks, portable storage devices, non-volatile memories (flash memories), optical data storage devices, and the like, and the computer-readable recording medium may be implemented in a form of carrier waves (for example, transmission through the Internet). The computer readable recording medium may also be distributed over a network coupled computer systems so that computer-readable codes are stored and executed in a distributed manner.

While the present invention has been particularly shown and described with reference to exemplary embodiments thereof, it will be understood by those skilled in the art that various changes in form and details may be made therein without departing from the spirit and scope of the present invention as defined by the appended claims.

1. A virtual-particle-based splash particle simulation apparatus comprising:
a splash grid generation module configured to generate a grid including all splash particles of a current frame by using splash particle information of a previous frame;
a splash particle information collection module configured to collect splash particle information of a periphery of the grid by using the generated grid and splash particle information of an inner portion of the grid;
a virtual particle generation module configured to generate virtual particles by using the collected splash particle information; and
a virtual-particle-based simulation module configured to perform simulation on the splash particles of the current frame by using information on the virtual particles and to allow the splash particles which are subject to the simulation to be input to the splash grid generation module in the next frame so as for the simulation to be performed.

2. The virtual-particle-based splash particle simulation apparatus according to claim 1, wherein the splash grid generation module analyzes a distribution of the splash particles on the basis of the splash particle information of the previous frame to generate a bounding box and generates a grid structure on the basis of the bounding box.

3. The virtual-particle-based splash particle simulation apparatus according to claim 1, wherein the splash particle information collection module collect the splash particle information including position information of the splash particles, velocity information of the splash particles, and density information indicating a degree of clustering of the splash particles by searching peripheral splash particles around each vertex of the generated grid.

4. The virtual-particle-based splash particle simulation apparatus according to claim 3, wherein the splash particle information collection module accumulates necessary values by searching the splash particles influencing each vertex of the grid by using the same hash structure as that of the grid, obtains an average value of the accumulated values after the searching of all the peripheral splash particles around each vertex is ended, and collects the average value as the splash particle information.

5. The virtual-particle-based splash particle simulation apparatus according to claim 4, wherein the splash particle information collection module calculates distances between the vertexes of the grid and the splash particles and accumulates the values by taking into consideration a degree of influence of the splash particles on the respective vertexes.

6. The virtual-particle-based splash particle simulation apparatus according to claim 3, wherein the virtual particle generation module generates the virtual particles by using the splash particle information collected on the basis of the vertexes of the grid.

7. The virtual-particle-based splash particle simulation apparatus according to claim 6, wherein the virtual particle generation module generates one virtual particle per vertex and determines a position of the virtual particle on the basis of the collected splash particle information.

8. The virtual-particle-based splash particle simulation apparatus according to claim 7, wherein the virtual-particle-based simulation module performs fluid simulation on the splash particles of the current frame by using a smoothed particle hydrodynamics (SPH) method.

9. The virtual-particle-based splash particle simulation apparatus according to claim 8, wherein in the performing of the fluid simulation on the splash particles in the virtual-particle-based simulation module, the virtual particles merely influence the splash particles in the simulation and, after the simulation on the current frame is ended, the virtual particles disappear.

10. The virtual-particle-based splash particle simulation apparatus according to claim 9, wherein the virtual-particle-based simulation module obtains an acceleration of the splash particle of the current frame by using the virtual particles and adjusts a velocity and position of the splash particle by using the obtained acceleration.

11. A splash particle simulation method in a virtual-particle-based splash particle simulation apparatus, comprising:
a splash grid generation step of generating a grid including all splash particles of a current by using splash particle information of a previous frame as an input received by the splash particle simulation apparatus;
an information collection step of collecting splash particle information of a periphery of the grid by using the generated grid and splash particle information of an inner portion of the grid in the splash particle simulation apparatus;
a virtual particle generation step of generating virtual particles by using the collected splash particle information in the splash particle simulation apparatus ; and
a simulation step of performing simulation on the splash particles of the current frame by using information on the virtual particles and allowing the splash particles which are subject to the simulation to be input to the splash grid generation module in the next frame so as for the simulation to be performed in the splash particle simulation apparatus.

12. The splash particle simulation method according to claim 11, the grid generation step includes analyzing a distribution of the splash particles on the basis of the splash particle information of the previous frame to generate a bounding box and generating a grid structure on the basis of the bounding box.

13. The splash particle simulation method according to claim 11, wherein the information collection step includes collecting the splash particle information including position information of the splash particles, velocity information of the splash particles, and density information indicating a degree of clustering of the splash particles by searching peripheral splash particles around each vertex of the generated grid.

14. The splash particle simulation method according to claim 13, wherein the information collection step includes accumulating necessary values by searching the splash particles influencing each vertex of the grid by using the same hash structure as that of the grid, obtaining an average value of the accumulated values after the searching of all the peripheral splash particles around each vertex is ended, and collecting the average value as the splash particle information.

15. The splash particle simulation method according to claim 14, wherein the information collection step includes calculating distances between the vertexes of the grid and the splash particles and accumulating the values by taking into consideration a degree of influence of the splash particles on the respective vertexes.

16. The splash particle simulation method according to claim 13, wherein the virtual particle generation step includes generating the virtual particles by using the splash particle information collected on the basis of the vertexes of the grid.

17. The splash particle simulation method according to claim 16, wherein the virtual particle generation step includes generating one virtual particle per vertex and determining a position of the virtual particle on the basis of the collected splash particle information.

18. The splash particle simulation method according to claim 17, wherein the simulation step includes performing fluid simulation on the splash particles of the current frame by using an SPH method.

19. The splash particle simulation method according to claim 18, wherein, in the simulation step, in the performing of the fluid simulation on the splash particles, the virtual particles merely influence the splash particles in the simulation and, after the simulation on the current frame is ended, the virtual particles disappear.

20. The splash particle simulation method according to claim 19, wherein the simulation step includes obtaining an acceleration of the splash particle of the current frame by using the virtual particles and adjusting a velocity and position of the splash particle by using the obtained acceleration.

21. (canceled)
